(19) United States
(12) Patent Application Publication
(10) Pub. No.: US 2026/0277305 A1
(43) Pub. Date: Sep. 17, 2026

(54) DISPLAY METHOD AND APPARATUS FOR HEAD-MOUNTED DEVICE, AND DEVICE, SYSTEM AND MEDIUM

(71) Applicant: GOERTEK INC., Weifang, Shandong (CN)

(72) Inventors: Mingming YANG, Weifang, Shandong (CN); Xudong QIU, Weifang, Shandong (CN); Yufeng LI, Weifang, Shandong (CN)

(21) Appl. No.: 19/469,607

(22) PCT Filed: Jun. 18, 2024
(86) PCT No.: PCT/CN2024/099732

§ 371 Date: Sep. 26, 2025

(30) Foreign Application Priority Data
Oct. 12, 2023 (CN) 202311322602.4

(51) Int. Cl. G06F 3/01; G06T 19/00

(52) U.S. Cl. CPC G06F 3/011; G06T 19/006

(57) ABSTRACT

A display method and apparatus for a head-mounted device, and a device, a system and a medium are disclosed. The display method is applied to a first electronic device, and includes: acquiring service requirement information of at least one head-mounted device; in response to determining that each head-mounted device requires a first target service among first services and a second target service among second services according to the service requirement information, acquiring first image data of the first target service, and acquiring second image data of the second target service from a second electronic device; synthesizing the first and second image data to obtain synthesized image data; and sending it to the head-mounted device, the head-mounted device displays it, image display being highly limited due to that the head-mounted device can display only image data of a service executing on a data processing unit can be solved.

The present application claims a priority to the Chinese Patent Application No. 202311322602.4, entitled “DISPLAY METHOD AND APPARATUS FOR HEAD-MOUNTED DEVICE, AND DEVICE, SYSTEM AND MEDIUM” filed with China Patent Office on Oct. 12, 2023, the entire contents of which are incorporated into the present application by reference.

### TECHNICAL FIELD

The present disclosure relates to a technical field of head-mounted devices, and more particularly, to a display method for a head-mounted device, a display apparatus for a head-mounted device, an electronic device, a head-mounted display system, and a computer-readable storage medium.

### DESCRIPTION OF RELATED ART

With the development of science, technology and economy, intelligent head-mounted devices (such as AR glasses) have been more and more widely used.

The intelligent head-mounted devices include integrated intelligent head-mounted devices and split-type intelligent head-mounted devices. A split-type intelligent head-mounted device includes a head-mounted display device and a data processing unit, the data processing unit performs data processing, and the head-mounted display device performs image display.

Currently, the head-mounted display device can only display an image of a service executing on the data processing unit, which results in a high limitation for the image display of existing intelligent head-mounted devices.

### SUMMARY

An object of the present disclosure is to provide a new technical solution for display for a head-mounted device.

According to a first aspect of the present disclosure, a display method for a head-mounted device is provided, which is applied to a first electronic device, the display method including:

acquiring service requirement information of at least one head-mounted device;

in response to determining that each of the at least one head-mounted device requires a first target service among first services and a second target service among second services according to the service requirement information, acquiring first image data of the first target service, and acquiring second image data of the second target service from a second electronic device;

synthesizing the first image data and the second image data to obtain synthesized image data; and

sending the synthesized image data to the head-mounted device, such that the head-mounted device displays the synthesized image data,

wherein the first service is a service that is executable on the first electronic device, and the second service is a service that is executable on the second electronic device.

Optionally, the display method further includes: before the acquiring the service requirement information of the at least one head-mounted device,

displaying an identifier of the first service;

acquiring an identifier of the second service from the second electronic device; and

displaying the identifier of the second service.

Optionally, there are at least two first target services, and the display method further includes:

acquiring priorities of the at least two first target services from the second electronic device; and

configuring operating frequencies of processing units executing the at least two first target services based on the priorities,

wherein priorities of the first target services are directly proportional to operating frequencies of corresponding processing units.

Optionally, the display method further includes:

acquiring an actual temperature of a processing unit of the first electronic device; and

in response to the actual temperature being greater than a preset temperature, reducing an operating frequency of a processing unit executing a first target service with a preset priority.

Optionally, there are at least two first target services, and the display method further includes:

acquiring priorities of the at least two first target services from the second electronic device; and

sending first image data corresponding to each of the at least two first target services to at least two head-mounted devices respectively according to the priorities,

wherein priorities of the first target services are directly proportional to priorities of sending orders of corresponding first image data.

Optionally, the display method further includes: before the acquiring the service requirement information of the at least one head-mounted device,

sending device identification information and device type information of the first electronic device to each of the at least one head-mounted device through an NFC communication connection, so that the head-mounted device establishes a WIFI communication connection with the first electronic device according to the device identification information and the device type information of the first electronic device.

Optionally, the synthesizing the first image data and the second image data to obtain the synthesized image data includes:

decoding the second image data to obtain second original image data;

synthesizing the second original image data and the first image data, to obtain synthesized original image data; and

encoding the synthesized original image data to obtain the synthesized image data.

According to a second aspect of the present disclosure, a display apparatus for a head-mounted device, which is applied to a first electronic device, is provided, the display apparatus including:

a first acquisition module configured to acquire service requirement information of at least one head-mounted device;

a second acquisition module configured to, in response to determining that each of the at least one head-mounted device requires a first target service among first services and a second target service among second services according to the service requirement information, acquire first image data of the first target service, and acquire second image data of the second target service from a second electronic device;

a synthesis module configured to synthesize the first image data and the second image data to obtain synthesized image data; and

a sending module configured to send the synthesized image data to the head-mounted device, such that the head-mounted device displays the synthesized image data,

wherein the first service is a service that is executable on the first electronic device, and the second service is a service that is executable on the second electronic device.

According to a third aspect of the present disclosure, an electronic device is provided, wherein the electronic device is the first electronic device according to the first aspect, and the electronic device includes the display apparatus for the head-mounted device according to the second aspect.

Alternatively, the electronic device includes a memory and a processor, wherein the memory is configured to store computer instructions, and the processor is configured to invoke the computer instructions from the memory to perform the display method for the head-mounted device according to the first aspect.

According to a fourth aspect of the present disclosure, a head-mounted display system including the first electronic device according to the third aspect and at least one head-mounted device,

Wherein, each of the at least one head-mounted device is configured to: send service requirement information to the first electronic device; and

receive and display the synthesized image data.

According to a fifth aspect of the present disclosure, a computer-readable storage medium having a computer program stored thereon is provided, wherein the computer program implements the display method for the head-mounted device when executed by a processor according to the first aspect.

The embodiment of the present disclosure provides a display method for a head-mounted device, the display method is applied to a first electronic device, and the display method includes: acquiring service requirement information of at least one head-mounted device; in response to determining that the each of the at least one head-mounted device requires a first target service among a first service and a second target service among a second service according to the service requirement information, acquiring first image data of the first target service, and acquiring second image data of the second target service from a second electronic device; synthesizing the first image data and the second image data to obtain synthesized image data; and sending the synthesized image data to the head-mounted device, such that the head-mounted device displays the synthesized image data, wherein the first service is a service that is executable on the first electronic device, and the second service is a service that is executable on the second electronic device. According to the display method, the displayed synthesized image data includes the first image data and the second image data, the first image data is image data of the first target service executing in the first electronic device, and the second image data is image data of the second target service executing in the second electronic device. Thus, when a user views the synthesized image data through the head-mounted device, both the image data of a service executing on the first electronic device and the image data of a service executing on the second electronic device can be seen. When the first electronic device is a data processing unit of the head-mounted device, the display method for the head-mounted device provided by the embodiment of the present disclosure solves the problem of image display being highly limited due to that the head-mounted device can display only image data of a service executing on a data processing unit, and improves the image display compatibility of the head-mounted device.

Other features and advantages of the present disclosure will become apparent from the following detailed description of exemplary embodiments of the present disclosure with reference to the accompanying drawings.

### BRIEF DESCRIPTION OF DRAWINGS

To more clearly illustrate the embodiments of the present application or the technical solutions in the related art, the drawings required to be used for the content of the embodiments or the related art will be briefly introduced in the following. Obviously, the drawings in the following description are merely some of the drawings of the present application, and for those of ordinary skill in the art, other drawings can also be obtained from the provided drawings without any creative effort.

FIG. 1 is a schematic flowchart of a display method for a head-mounted device according to an embodiment of the present disclosure;

FIG. 2 is a schematic diagram of a specific implementation process of the display method for the head-mounted device according to an embodiment of the present disclosure;

FIG. 3 is a schematic structural diagram of a display apparatus for the head-mounted device according to an embodiment of the present disclosure;

FIG. 4 is a schematic structural diagram of an electronic device according to an embodiment of the present disclosure.

Implementations, functional features, and advantages of the present disclosure will be further described with reference to the accompanying drawings and embodiments.

### DETAILED DESCRIPTIONS

The following clearly and completely describes the technical solutions in the embodiments of the present disclosure with reference to the accompanying drawings in the embodiments of the present disclosure, and obviously, the described embodiments are only a part of the embodiments of the present disclosure, but not all the embodiments. Based on the embodiments of the present disclosure, all other embodiments obtained by those skilled in the art without creative efforts fall within the protection scope of the present disclosure.

It should be noted that all directional indications (such as up, down, left, right, front, and rear) in the embodiments of the present disclosure are merely used to explain a relative position relationship and a movement condition and the like between components in a specific posture (as shown in the accompanying drawings), and if the specific posture changes, the directional indication changes accordingly.

In addition, if there are descriptions such as “first”, “second” and the like in the embodiments of the present disclosure, they are merely used for description purposes, and cannot be understood as indicating or implying relative importance thereof or implicitly indicating a quantity of indicated technical features. Thus, a feature defining with “first” and “second” may explicitly or implicitly include at least one of the features. In addition, “and/or” appearing throughout the text means that three parallel solutions are included, for example, “A and/or B” includes A solution, B solution, or solution that satisfies A and B simultaneously. In addition, the technical solutions among the various embodiments may be combined with each other, but must be based on the fact that the technical solutions can be realized by those of ordinary skill in the art, and when the combination of the technical solutions contradicts or cannot be realized, it should be considered that the combination of the technical solutions does not exist or fall within the protection scope claimed by the present disclosure.

In an application scenario of a display method for a head-mounted device provided by embodiments of the present disclosure, a first electronic device, a second electronic device and at least one head-mounted device are included.

The head-mounted device may be a device with a display function such as intelligent glasses or a helmet. In addition, any head-mounted device is in communication connection with the first electronic device.

Specifically, the first electronic device is a data processing unit of the head-mounted device. The first electronic device is a device having an operating system. The operating system may be an Android operating system, an iOS operating system, or another possible operating system, it is not specifically limited in the present disclosure.

The second electronic device is different from the first electronic device and is in communication connection with the first electronic device. In an example, the second electronic device may be a vehicle infotainment device.

Based on the display method for the head-mounted device provided in the embodiment of the present disclosure, the head-mounted device can view both an image of a service executing on the first electronic device and an image of a service executing on the second electronic device.

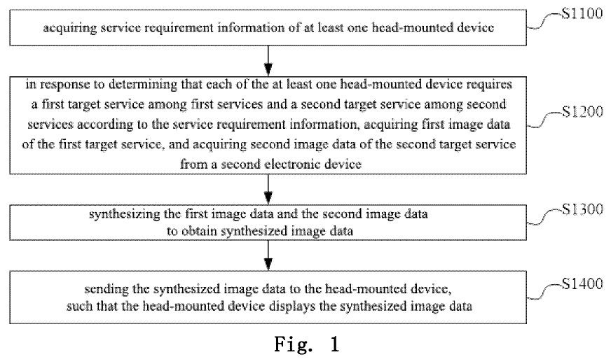

An embodiment of the present disclosure provides a display method for a head-mounted device, as shown in FIG. 1, the display method includes the following steps S1100 to S1400.

S1100: acquiring service requirement information of at least one head-mounted device.

In the embodiment of the present disclosure, the head-mounted device sends service requirement information of the head-mounted device itself to a first electronic device, to notify the first electronic device image data of what service are required to be displayed for the head-mounted device itself. The service corresponding to the image data that needs to be displayed by the head-mounted device may be from the first electronic device, or may be from a second electronic device that is in communication connection with the first electronic device and different from the first electronic device.

In an embodiment of the present disclosure, different service identifiers may be displayed on the first electronic device for a user to select through the head-mounted device, for example, by scanning through the head-mounted device, to select a service meeting the user's own requirements. Further, the head-mounted device uses a service that meets the requirement for the head-mounted device itself as a requirement service, and sends service requirement information to the first electronic device based on the requirement service. Based on this, in an embodiment of the present disclosure, the display method for the head-mounted device provided by the embodiment of the present disclosure further includes the following S1110 to S1112 before the S1100.

S1110: displaying an identifier of the first service;

S1111: acquiring an identifier of the second service from the second electronic device; and S1112: displaying the identifier of the second service.

In the embodiment of the present disclosure, the first service is a service that can be run on the first electronic device, and the second service is a service that can be run on the second electronic device. The service in the embodiment of the present disclosure may be understood as an application (APP).

It should be noted that the service that can be run on the first electronic device specifically refer to the service installed on the first electronic device. Likewise, the service that can be run on the second electronic device specifically refer to the service installed on the second electronic device. It will be understood that the service that cannot be run on the first electronic device specifically refers to the service that is not installed on the first electronic device. Likewise, the service that cannot be run on the second electronic device specifically refers to the service that is not installed on the second electronic device.

In an example, the first service may be a chat service, a film and television service, and a short video service. The second service may be an audio service, a map service, or the like.

Since the first electronic device can originally run the first service, when an identifier of the first service is stored in the first electronic device, the first electronic device may directly display the identifier of the first service. Alternatively, when the first electronic device does not directly store the identifier of the first service, the first electronic device may generate the identifier of the first service based on information related to the identifier of the first service, and then display the generated identifier of the first service.

Correspondingly, the first electronic device cannot run the second service, and therefore the identifier of the second service is not stored in the first electronic device. Based on this, the first electronic device needs to acquire the identifier of the second service from the second electronic device. When the identifier of the second service is acquired, the identifier of the second service may be displayed.

Of course, the first electronic device may alternatively obtain information related to the identifier of the second service from the second electronic device, generate the identifier of the second service based on the information related to the identifier of the second service, and then display the generated identifier of the second service.

In an example, each of the identifier of the first service and the identifier of the second service may be a QR code.

In an example, the identifier of the first service and the identifier of the second service are QR codes, and when the user wants to view image data of a chat service through the head-mounted device, the user may scan an identifier of the chat service by using intelligent glasses. After scanning the identifier of the chat service, the intelligent glasses bind an identifier of the intelligent glasses and the identifier of the chat service together as service requirement information, and send it to the first electronic device. Based on this, after receiving the service requirement information, the first electronic device determines that the identifier of the chat service is bound to the identifier of the intelligent glasses, and in this case, determines that the requirement service of the intelligent glasses is the chat service.

In the embodiment of the present disclosure, according to the above steps S1110 to S1112, the user may be notified of which services are supported by the first electronic device. The user selects a requirement service from services supported by the first electronic device, to avoid a problem that the first electronic device cannot provide image data of a service required by the user. In addition, the user is prevented from manually inputting a service required by the user on the head-mounted device.

In another embodiment of the present disclosure, when the first electronic device does not display the identifier of the first service and the identifier of the second service, the user may manually input notification information of a service that meets his/her own requirement on the head-mounted device,, and the head-mounted device sends service requirement information to the first electronic device according to the notification information manually input by the user.

S1200: in response to determining that each of the at least one head-mounted device requires a first target service among a first service and a second target service among a second service according to the service requirement information, acquiring first image data of the first target service, and acquiring second image data of the second target service from a second electronic device.

In the embodiment of the present disclosure, the first target service is a service that meets a user requirement among the first service, and the second target service is a service that meets a user requirement among the second service.

In the embodiment of the present disclosure, in response to determining that the head-mounted device requires the first target service among the first service that can be run on the first electronic device and the second target service among the second service that can be run on the second electronic device according to the service requirement information, the first electronic device acquires the first image data of the first target service and the second image data of the second target service. Since the second target service is executing on the second electronic device, the first electronic device acquires the second image data of the second target service from the second electronic device.

It should be noted that when acquiring the first image data of the first target service, the first electronic device first runs the first target service; and when the first electronic device acquires the second image data of the second target service, if the second target service is not run on the second electronic device, the first electronic device needs to instruct the second electronic device to run the second target service.

When first target services required by different head-mounted devices are different at a same moment, the first electronic device needs to simultaneously run the first target services of the different head-mounted devices. In an example, if the first target service required by a first head-mounted device is a chat service, and the first target service required by a second head-mounted device is a video service, the first electronic device runs both the chat service and the video service.

The first electronic device may simultaneously run different services in a manner that: when the first electronic device includes a multi-core processor, each processor runs one service; or at least two independent operating systems are created in the first electronic device by using a containerization technology, and each operating system runs one service; or independent virtual screens corresponding to different services are created in the first electronic device by using a virtual screen technology, and image data of each service is displayed on one virtual screen.

S1300: synthesizing the first image data and the second image data to obtain synthesized image data.

In an embodiment of the present disclosure, the synthesis method may be up-down splicing, left-right splicing, or the like.

In the embodiment of the present disclosure, the first image data and the second image data are synthesized to obtain synthesized image data.

S1400: sending the synthesized image data to the head-mounted device, such that the head-mounted device displays the synthesized image data.

In the embodiment of the present disclosure, the first electronic device sends the synthesized image data to the head-mounted device. After receiving the synthesized image data sent by the first electronic device, the head-mounted device displays the synthesized image data. The displayed synthesized image data includes the first image data and the second image data, the first image data is image data of the first target service executing on the first electronic device, and the second image data is image data of the second target service executing on the second electronic device. Thus, when the user views the synthesized image data through the head-mounted device, both the image data of a service executing on the first electronic device and the image data of a service executing on the second electronic device can be seen. When the first electronic device is a data processing unit of the head-mounted device, the display method for the head-mounted device provided by the embodiment of the present disclosure solves the problem of image display being highly limited due to that the head-mounted device can display only image data of a service executing on a data processing unit, and improves the image display compatibility of the head-mounted device.

Corresponding to the above S1200, when it is determined that the head-mounted device requires the first target service among the first service according to the service requirement information, the first electronic device directly acquires the first image data of the first target service, and sends the first image data of the first target service to the head-mounted device for display by the head-mounted device.

Corresponding to the above S1200, when it is determined that the head-mounted device requires the second target service among the second service according to the service requirement information, the first electronic device directly acquires the second image data of the second target service from the second electronic device, and sends the second image data of the second target service to the head-mounted device for display by the head-mounted device.

It may be understood that, when it is determined that the head-mounted device requires the first target service among the first service according to the service requirement information, and there are at least two first target services, first image data of the at least two first target services may be synthesized, and the above S1400 is performed for display by the head-mounted device. Besides, when it is determined that the head-mounted device requires the second target service among the second service according to the service requirement information, and there are at least two second target services, second image data of the at least two second target services may be synthesized, and the above S1400 is performed for display by the head-mounted device.

The embodiment of the present disclosure provides a display method for a head-mounted device, the display method is applied to a first electronic device, and the display method includes: acquiring service requirement information of at least one head-mounted device; in response to determining that each of the at least one head-mounted device requires a first target service among a first service and a second target service among a second service according to the service requirement information, acquiring first image data of the first target service, and acquiring second image data of the second target service from a second electronic device; synthesizing the first image data and the second image data to obtain synthesized image data; and sending the synthesized image data to the head-mounted device, such that the head-mounted device displays the synthesized image data, wherein the first service is a service that is executable on the first electronic device, and the second service is a service that is executable on the second electronic device. According to the display method, the displayed synthesized image data includes the first image data and the second image data, the first image data is image data of the first target service executing in the first electronic device, and the second image data is image data of the second target service executing in the second electronic device. Thus, when a user views the synthesized image data through the head-mounted device, both the image data of a service executing on the first electronic device and the image data of a service executing on the second electronic device can be seen. When the first electronic device is a data processing unit of the head-mounted device, the display method for the head-mounted device provided by the embodiment of the present disclosure solves the problem of image display being highly limited due to that the head-mounted device can display only image data of a service executing on a data processing unit, and improves the image display compatibility of the head-mounted device.

In an embodiment of the present disclosure, there are at least two first target services. For example, the requirement service of one head-mounted device is at least two among the first service. For another example, the requirement service of at least two head-mounted devices is two different first target services among the first service. In this case, the display method for the head-mounted device provided by the embodiment of the present disclosure further includes the following S1510 and S1511.

S1510: acquiring priorities of the at least two first target services from the second electronic device.

In the embodiment of the present disclosure, the second electronic device includes an input device, such as a touchscreen. After determining priorities of different first target services, the user may input indication information specifying the priorities of the different first target services on the second electronic device. After receiving the indication information, the second electronic device sends the priorities of the different first target services to the first electronic device based on the indication information. Based on this, the first electronic device acquires priorities of different first target services from the second electronic device.

S1511: configuring operating frequencies of processing units executing the at least two first target services based on the priorities.

Here, priorities of the first target services are directly proportional to operating frequencies of corresponding processing units.

In the embodiment of the present disclosure, when there are at least two first target services, priorities of the at least two first target services may be set. A higher priority of the first target service indicates a higher operating frequency of a processing unit executing the first target service. In this way, the first target service with a higher priority can run more smoothly.

It may be understood that a higher operating frequency of the processing unit indicates a higher temperature rise of the processing unit. When the temperature of the processing unit is too high, there is at risk of hardware damage for the processing unit. To avoid excessive temperature of the processing unit, based on the embodiments shown in S1510 and S1511, the display method for the head-mounted device provided by the embodiment of the present disclosure further includes the following S1610 and S1611.

S1610: acquiring an actual temperature of a processing unit of the first electronic device.

In an embodiment of the present disclosure, the actual temperature of the processing unit in the above S1610 may be an actual temperature of any processing unit in the first electronic device, or may be an average actual temperature corresponding to actual temperatures of all processing units in the first electronic device, or may be an actual temperature of a processing unit with a highest operating frequency in the first electronic device. It is not limited in the embodiment of the present disclosure.

S1611: in response to the actual temperature being greater than a preset temperature, reducing an operating frequency of a processing unit executing a first target service with a preset priority.

In the embodiment of the present disclosure, a first preset temperature is a maximum temperature at which the processing unit can run safely.

In an embodiment of the present disclosure, the first target service with the preset priority may be a first target service with a highest priority, or may be a first target service with a lowest priority.

When the actual temperature of the processing unit of the first electronic device is greater than the preset temperature, it indicates that the processing unit of the first electronic device cannot run safely.

When the actual temperature of the processing unit of the first electronic device is greater than the preset temperature, and the first target service with the preset priority is a first target service with a lowest priority, the operating frequency of the processing unit of the first target service with the preset priority is reduced, so that smooth executing of the first target service with the highest priority can be ensured while the processing unit is cooled.

When the actual temperature of the processing unit of the first electronic device is greater than the preset temperature, and the first target service with the preset priority is a first target service with a highest priority, the operating frequency of the processing unit of the first target service with the preset priority is reduced, so that the processing unit can be quickly cooled.

When the operating frequency of the processing unit of the first target service with the preset priority is reduced, the operating frequency of the processing unit operating the first target service with the preset priority may be reduced to a preset percentage of the current operating frequency. For example, the preset percentage may be 80%, and may also be other percentage, which is not limited in the present disclosure.

Corresponding to the above S1611, when the actual temperature is less than or equal to the preset temperature, it indicates that the processing unit of the first electronic device runs safely. In this case, the operating frequency of the processing unit is not adjusted.

Of course, another manner for reducing the operating frequency of the processing unit may also be used to reduce the temperature of the processing unit of the first electronic device.

For example, preset temperatures of a plurality of different levels are set, and the lower of the preset temperature, the corresponding amplitude of the operating frequency is further reduced. For another example, corresponding preset temperatures are set for different processing units, and when an actual temperature of one processing unit exceeds the corresponding preset temperature, an operating frequency of the processing unit is reduced.

For another example, a preset temperature is set, and when a temperature is not reduced after an operating frequency of a processing unit executing the first target service with the preset priority is reduced, an operating frequency of a processing unit executing the first target service with a priority higher than the preset priority is continuously reduced.

It should be noted that the strategy for reducing the temperature of the processing unit by reducing the operating frequency of the processing unit is within the protection scope of the present disclosure.

In an embodiment of the present disclosure, in a case that there are at least two first target services, the display method for the head-mounted device provided by the embodiment of the present disclosure further includes the following S1710 and S1711.

S1710: acquiring priorities of the at least two first target services from the second electronic device.

It should be noted that specific implementation of the S1710 is the same as that of the S1510, and details are not described herein again.

S1711: sending first image data corresponding to each of the at least two first target services to at least two head-mounted devices respectively according to the priorities.

Here, priorities of the first target services are directly proportional to priorities of sending orders of corresponding first image data.

In the embodiment of the present disclosure, when there are at least two first target services, priorities of the at least two first target services may be set. A higher priority of the first target service indicates sending the first image data corresponding to the first target service in advance. In this way, the first image data of the first target service with a high priority may be sent in advance.

It should be noted that, when the first image data of the first target service is data in synthesized image data, if the first target service corresponding to the first image data in the synthesized image data has a high priority, the synthesized image data should also be sent in advance.

It will be understood that before the first electronic device acquires service requirement information of at least one head-mounted device, a communication connection needs to be established between the first electronic device and the at least one head-mounted device. Based on this, the display method for the head-mounted device provided by the embodiment of the present disclosure further includes the following S1120 before the S1100.

S1120: sending device identification information and device type information of the first electronic device to each of the at least one head-mounted device through an NFC communication connection, so that the head-mounted device establishes a WIFI communication connection with the first electronic device according to the device identification information and the device type information of the first electronic device.

In the embodiment of the present disclosure, the head-mounted device first establishes an NFC communication connection to the first electronic device. Based on this, the first electronic device sends device identification information and device type information of the first electronic device to the head-mounted device.

The device identification information is used for the head-mounted device to establish a WIFI communication connection with the first electronic device at a longer transmission distance. The device identification information may be specifically an IP and a PORT of the first electronic device.

The device type information is identity information used to notifying that the head-mounted device itself is the first electronic device. When the head-mounted device determines that the device identification information is the device identification information of the first electronic device according to the device type information, the head-mounted device establishes a WIFI communication connection to the first electronic device based on the device identification information acquired through the NFC communication connection. Through the device type information, the head-mounted device can avoid establishing the WIFI communication connection with the second electronic device.

Similarly, before the first electronic device acquires the second image data from the second electronic device, the first electronic device also needs to establish a communication connection to the second electronic device. Based on this, the display method for the head-mounted device provided by the embodiment of the present disclosure further includes the following S1130 before the S1100.

S1130: sending the device identification information and the device type information of the first electronic device to the second electronic device through the NFC communication connection, so that the second electronic device establishes the WIFI communication connection with the first electronic device according to the device identification information and the device type information of the first electronic device.

It should be noted that specific implementation of the S1130 is similar to the specific implementation of the S1120, which will not be repeated in the present disclosure.

It will be understood that, in general, when the second electronic device sending the second image data of the second target service to the first electronic device, it sends encoded image data. When synthesizing the second image data of the second target service, the first electronic device needs to first decode and then synthesize the second image data. Based on this, the above S1300 may be specifically implemented by using the following S1310 to S1312.

S1310: decoding the second image data to obtain second original image data.

S1311: synthesizing the second original image data and the first image data to obtain synthesized original image data.

In the embodiment of the present disclosure, the first image data is unencoded original image data.

S1312: encoding the synthesized original image data to obtain the synthesized image data.

In the embodiment of the present disclosure, the synthesized image data that can be directly sent to the head-mounted device can be obtained through the above S1312.

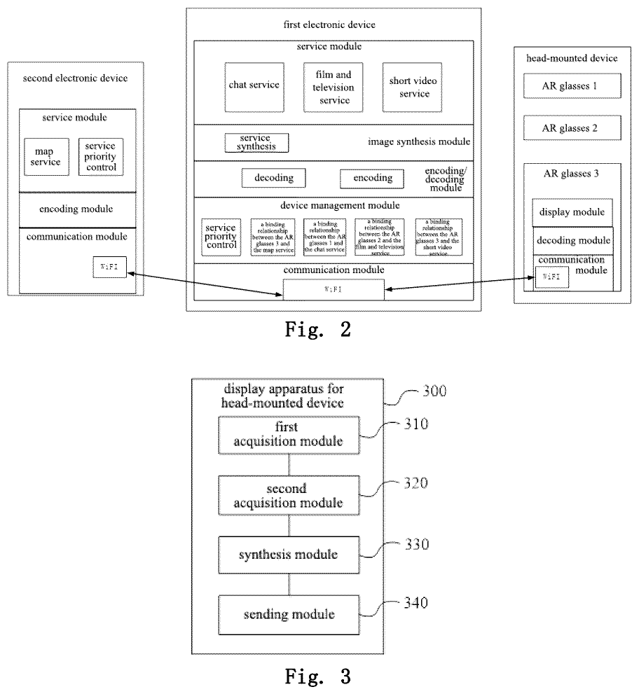

With reference to the foregoing embodiments, in an example of the present disclosure, there are three head-mounted devices which are AR glasses (specifically, AR glasses 1, AR glasses 2, and AR glasses 3), the first services are a chat service, a film and television service, and a short video service, the second service is a map service, the first target service corresponding to the AR glasses 1 is the chat service, the first target service corresponding to the AR glasses 2 is the film and television service, the first target service corresponding to the AR glasses 3 is the short video service, and the second target service corresponding to the AR glasses 3 is the map service. A specific implementation process of the display method for the head-mounted device provided by the embodiment of the present disclosure may be as shown in FIG. 2, and the specific description is as follows:

The first electronic device is divided into a service module, an image synthesis module, an encoding/decoding module, a device management module, and a communication module according to functions.

The AR glasses are divided into a display module, a decoding module and a communication module according to functions.

The second electronic device is divided into a service module, an encoding/decoding module, and a communication module according to functions. The encoding/decoding module specifically includes two sub-modules, i.e. the encoding module and the decoding module.

The AR glasses 1 scan an identifier of the chat service provided by the service module in the first electronic device, the AR glasses 2 scan an identifier of the film and television service provided by the service module in the first electronic device, and the AR glasses 3 scan an identifier of the short video service and an identifier of the map service provided by the service module in the first electronic device. The service module in the first electronic device acquires the identifier of the map service from the second electronic device by using the communication module in the first electronic device.

The device management module in the first electronic device records a binding relationship between the AR glasses 1 and the chat service into a chat service device submodule, records a binding relationship between the AR glasses 2 and the film and television service into a film and television service device submodule, records a binding relationship between the AR glasses 3 and the short video service into a short video service device submodule, and records a binding relationship between the AR glasses 3 and the map service into a map service device submodule.

The service module of the first electronic device determines, based on the device management module, to send image data of the chat service to the AR glasses 1, and at this time, the image data of the chat service is sent to the encoding/decoding module for encoding by the encoding/decoding module, and is sent to the communication module of the AR glasses 1 through the communication module of the first electronic device. The decoding module of the AR glasses 1 acquires the image data of the chat service encoded by the first electronic device through the communication module of the AR glasses 1, decodes the image data, and then sends the image data to the display module of the AR glasses 1 for display by the display module, and at this time, the AR glasses 1 displays the image data of the chat service, and the same for the AR glasses 2.

The service module of the first electronic device determines, based on the device management module, to send image data of the short video service and image data of the map service to the AR glasses 3, and at this time, the image data of the short video service is acquired, and the image data of the map service from the second electronic device is acquired. The encoding/decoding module in the first electronic device decodes the acquired image data of the map service, and sends it to the image synthesis module. The image synthesis module acquires image data of the short video service from the service module of the first electronic device, synthesizes the image data of the short video service and the decoded image data of the map service, and then sends it to the encoding/decoding module in the first electronic device, so that the encoding/decoding module in the first electronic device encodes it to obtain synthesized image data, and sends the synthesized image data to the AR glasses 3 through the communication module. The decoding module of the AR glasses 3 acquires the synthesized image data encoded by the first electronic device through the communication module of the AR glasses 3, decodes the synthesized image data, and sends the synthesized image data to the display module of the AR glasses 3 for display by the display module. In this case, the AR glasses 3 displays the synthesized image data.

In addition, the service module in the second electronic device may be further divided into a submodule for managing the map service and a submodule for controlling the priority among services. The device management module in the first electronic device may be further divided into a submodule for controlling the priority among services, a chat service device submodule for recording a binding relationship between the AR glasses 1 and the chat service, a film and television service device submodule for recording a binding relationship between the AR glasses 2 and the film and television service, a short video service device submodule for recording a binding relationship between the AR glasses 3 and the short video service, and a map service device submodule for recording a binding relationship between the AR glasses 3 and the map service.

It will be understood that data exchange may be performed between modules inside the first electronic device, the AR glasses, and the second electronic device.

An embodiment of the present disclosure also provides a display apparatus 300 for a head-mounted device, the display apparatus 300 for the head-mounted device is applied to a first electronic device, and as shown in FIG. 3, includes:

a first acquisition module 310 configured to acquire service requirement information of at least one head-mounted device;

a second acquisition module 320 configured to, in response to determining that each of the at least one head-mounted device requires a first target service among a first service and a second target service among a second service according to the service requirement information, acquire first image data of the first target service, and acquire second image data of the second target service from a second electronic device;

a synthesis module 330 configured to synthesize the first image data and the second image data to obtain synthesized image data; and

a sending module 340 configured to send the synthesized image data to the head-mounted device, such that the head-mounted device displays the synthesized image data,

wherein the first service is a service that is executable on the first electronic device, and the second service is a service that is executable on the second electronic device.

In the apparatus, the displayed synthesized image data includes the first image data and the second image data, the first image data is image data of the first target service executing on the first electronic device, and the second image data is image data of the second target service executing on the second electronic device. Thus, when the user views the synthesized image data through the head-mounted device, both the image data of a service executing on the first electronic device and the image data of a service executing on the second electronic device can be seen. When the first electronic device is a data processing unit of the head-mounted device, the display method for the head-mounted device provided by the embodiment of the present disclosure solves the problem of image display being highly limited due to that the head-mounted device can display only image data of a service executing on a data processing unit, and improves the image display compatibility of the head-mounted device.

In an embodiment of the present disclosure, the display apparatus 300 for the head-mounted device provided by the embodiment of the present disclosure further includes:

a first display module configured to display an identifier of the first service;

a third acquisition module configured to acquire an identifier of the second service from the second electronic device; and

a second display module configured to display the identifier of the second service.

In an embodiment of the present disclosure, there are at least two first target services, and the display apparatus 300 for the head-mounted device provided by the embodiment of the present disclosure further includes:

a fourth acquisition module configured to acquire priorities of the at least two first target services from the second electronic device; and

a configuration module configured to configure, operating frequencies of processing units executing the at least two first target services based on the priorities,

wherein priorities of the first target services are directly proportional to operating frequencies of corresponding processing units.

In an embodiment of the present disclosure, the display apparatus 300 for the head-mounted device provided by the embodiment of the present disclosure further includes:

a fifth acquisition module configured to acquire an actual temperature of a processing unit of the first electronic device; and

a frequency modulation module configured to, in response to the actual temperature being greater than a preset temperature, reduce an operating frequency of a processing unit executing a first target service with a preset priority.

In an embodiment of the present disclosure, there are at least two first target services, and the display apparatus 300 for the head-mounted device provided by the embodiment of the present disclosure further includes:

a sixth acquisition module configured to acquire priorities of the at least two first target services from the second electronic device; and

a sending module configured to send first image data corresponding to each of the at least two first target services to at least two head-mounted devices respectively according to the priorities,

wherein priorities of the first target services are directly proportional to priorities of sending orders of corresponding first image data.

In an embodiment of the present disclosure, the display apparatus 300 for the head-mounted device provided by the embodiment of the present disclosure further includes:

a communication module configured to, send device identification information and device type information of the first electronic device to each of the at least one head-mounted device through an NFC communication connection, so that the head-mounted device establishes a WIFI communication connection with the first electronic device according to the device identification information and the device type information of the first electronic device.

In an embodiment of the present disclosure, the synthesis module 330 is specifically configured for:

decoding the second image data to obtain second original image data;

synthesizing the second original image data and the first image data to obtain synthesized original image data; and

encoding the synthesized original image data to obtain the synthesized image data.

An embodiment of the present disclosure also provides an electronic device 400, the electronic device is the first electronic device according to any one of the above embodiments, and the electronic device includes the display apparatus 300 for the head-mounted device according to any one of the above apparatus embodiments.

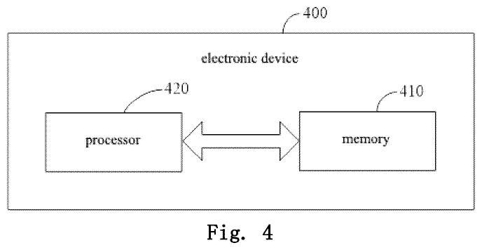

Alternatively, as shown in FIG. 4, the electronic device 400 includes a memory 410 and a processor 420, the memory 410 is configured to store computer instructions, and the processor 420 is configured to invoke the computer instructions from the memory 410, to perform the display method for the head-mounted device according to any one of the method embodiments.

An embodiment of the present disclosure also provides a head-mounted display system including the first electronic device according to any one of the above embodiments and at least one head-mounted device, wherein:

the head-mounted device is configured to send service requirement information to the first electronic device; and

receive and display the synthesized image data.

An embodiment of the present disclosure also provides a computer-readable storage medium having a computer program stored thereon, wherein the computer program, implements the display method for the head-mounted device according to any one of the above method embodiments when executed by a processor.

The present disclosure may be a system, a method and/or a computer program product. The computer program product may include a computer-readable storage medium (or media) having computer-readable program instructions thereon for making a processor to carry out aspects of the present disclosure.

The computer-readable storage medium may be a tangible device that may retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein may be downloaded to respective computing/processing devices from a computer-readable storage medium, or to an external computer or external storage device via a network, for example, the Internet, a local area network, a wide area network and/or a wireless network. The network may include copper transmission cables, optical fiber transmission, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In scenarios involving the remote computer, the remote computer may be connected to the user's computer through any type of network, including a local area network (LAN) or a wide area network (WAN), or may be connected to an external computer (for example, through the Internet using an Internet Service Provider). In some embodiments, state information of the computer-readable program instructions may be used to personalize the electronic circuitry, including, for example, programmable logic circuitry, field-programmable gate arrays (FPGA), or programmable logic arrays (PLA), the electronic circuitry may execute the computer-readable program instructions to implement aspects of the present disclosure.

Aspects of the present disclosure are described herein with reference to flowchart illustrations and/or block diagrams of the method, apparatus (system), and computer program product according to embodiments of the present disclosure. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of general-purpose computers, special-purpose computers, or other programmable data processing apparatus to produce a machine, such that the instructions, which execute via the processor of the computer or other programmable data processing apparatus, create means for implementing the functions/acts specified in one or more blocks of the flowchart illustrations and/or block diagrams. These computer-readable program instructions may also be stored in a computer-readable storage medium, that the instructions makes a computer, a programmable data processing apparatus, and/or other devices to function in a particular manner, thereby, the computer-readable storage medium having instructions stored therein includes an article of manufacture including instructions which implement aspects of the function/act specified in one or more blocks of the flowchart illustrations and/or block diagrams.

The computer-readable program instructions may also be loaded onto a computer, other programmable data processing apparatus, or other devices to cause a series of operational steps to be performed on the computer, other programmable data processing apparatus, or other devices to produce a computer implemented process, such that the instructions which execute on the computer, other programmable data processing apparatus, or other devices implement the function/act specified in one or more blocks of the flowchart illustrations and/or block diagrams.

The flowchart illustrations and block diagrams in the Figures illustrate the architecture, functionality, and operation of possible implementations of the system, method, and computer program product according to various embodiments of the present disclosure. In this regard, each block in the flowchart illustrations or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or can be implemented by combinations of special-purpose hardware and computer instructions. It is well known to those skilled in the art that implementation by hardware, implementation by software, and implementation by a combination of software and hardware are all equivalent.

It should be noted that terms such as “include”, “comprise” or any other variation thereof are intended to encompass a non-exclusive inclusion such that a process, method, article or system that includes a series of elements includes not only those elements, but also other elements not explicitly listed, or elements inherent to such a process, method, article or system. Without further limitation, the element defined by the phrase “including a . . . ” does not preclude the presence of additional identical elements in the process, method, article or system including the element.

The sequence numbers of the embodiments of the present disclosure are merely for description, and do not represent the preference of the embodiments.

Through the description of the foregoing implementations, a person skilled in the art may clearly understand that the method in the foregoing embodiments may be implemented by using software and a necessary general hardware platform, or may be implemented by using hardware, but in many cases, the former may be better. Based on such understanding, the technical solution of the present disclosure essentially or the part contributing to the prior art may be embodied in the form of a software product, and the computer software product is stored in a storage medium (such as a ROM/RAM, a magnetic disk, or an optical disk) as above, and includes several instructions to enable a terminal device (which may be a mobile phone, a computer, a server, a television, or a network device, etc.) to execute the method of each embodiment of the present disclosure.

The above descriptions are only preferred embodiments of the present disclosure, and are not intended to limit the patent scope of the present disclosure, and any equivalent structural transformation made by using the content of the specification and the accompanying drawings of the present disclosure or direct/indirect applications in other related technical fields under the inventive concept of the present disclosure are included in the patent protection scope of the present disclosure.

1. A display method for a head-mounted device, wherein the display method is applied to a first electronic device, and the display method comprises:
acquiring service requirement information of at least one head-mounted device;
in response to determining that each of the at least one head-mounted device requires a first target service among first services and a second target service among second services according to the service requirement information, acquiring first image data of the first target service, and acquiring second image data of the second target service from a second electronic device;
synthesizing the first image data and the second image data to obtain synthesized image data; and
sending the synthesized image data to the head-mounted device, such that the head-mounted device displays the synthesized image data,
wherein the first service is a service that is executable on the first electronic device, and the second service is a service that is executable on the second electronic device.

2. The display method of claim 1, further comprising: before the acquiring the service requirement information of the at least one head-mounted device,
displaying an identifier of the first service;
acquiring an identifier of the second service from the second electronic device; and
displaying the identifier of the second service.

3. The display method of claim 1, wherein there are at least two first target services, and the display method further comprises:
acquiring priorities of the at least two first target services from the second electronic device; and
configuring operating frequencies of processing units executing the at least two first target services based on the priorities,
wherein priorities of the first target services are directly proportional to operating frequencies of corresponding processing units.

4. The display method of claim 3, further comprising:
acquiring an actual temperature of a processing unit of the first electronic device; and
in response to the actual temperature being greater than a preset temperature, reducing an operating frequency of a processing unit executing a first target service with a preset priority.

5. The display method of claim 1, wherein there are at least two first target services, and the display method further comprises:
acquiring priorities of the at least two first target services from the second electronic device; and
sending first image data corresponding to each of the at least two first target services to at least two head-mounted devices respectively according to the priorities,
wherein priorities of the first target services are directly proportional to priorities of sending orders of corresponding first image data.

6. The display method of claim 1, further comprising: before the acquiring the service requirement information of the at least one head-mounted device,
sending device identification information and device type information of the first electronic device to each of the at least one head-mounted device through an NFC communication connection, so that the head-mounted device establishes a WIFI communication connection with the first electronic device according to the device identification information and the device type information of the first electronic device.

7. The display method of claim 1, wherein the synthesizing the first image data and the second image data to obtain the synthesized image data comprises:
decoding the second image data to obtain second original image data;
synthesizing the second original image data and the first image data to obtain synthesized original image data; and
encoding the synthesized original image data to obtain the synthesized image data.

8. A display apparatus for a head-mounted device, wherein the display apparatus is applied to a first electronic device, and the display apparatus comprises:
a first acquisition module configured to acquire service requirement information of at least one head-mounted device;
a second acquisition module configured to, in response to determining that each of the at least one head-mounted device requires a first target service among first services and a second target service among second services according to the service requirement information, acquire first image data of the first target service, and acquire second image data of the second target service from a second electronic device;
a synthesis module configured to synthesize the first image data and the second image data to obtain synthesized image data; and
a sending module configured to send the synthesized image data to the head-mounted device, such that the head-mounted device displays the synthesized image data,
wherein the first service is a service that is executable on the first electronic device, and the second service is a service that is executable on the second electronic device.

9. An electronic device, wherein the electronic device is a first electronic device, and the first electronic device comprises the display apparatus for the head-mounted device according to claim 8.

10. A head-mounted display system, wherein the head-mounted display system comprises the first electronic device according to claim 9 and at least one head-mounted device,
wherein each of the at least one head-mounted device is configured to:
send service requirement information to the first electronic device; and
receive and display the synthesized image data.

11. A computer-readable non-volatile storage medium, wherein the computer-readable storage medium has a computer program stored thereon, and wherein the computer program implements the display method for the head-mounted device according to claim 1 when executed by a processor.

12. An electronic device, wherein the electronic device comprises a memory and a processor, wherein the memory is configured to store computer instructions, and the processor is configured to invoke the computer instructions from the memory, to perform the display method for the head-mounted device according to claim 1.
